(19) United States
(12) Patent Application Publication
(10) Pub. No.: US 2012/0117553 A1
(43) Pub. Date: May 10, 2012

(54) PROGRAMMATIC DISPATCH TO FUNCTIONS WITH MATCHING LINKAGE

(75) Inventors: Allan H. Kielstra, Ajax (CA); Andrew R. Low, Stittsville (CA); Marcel Mitran, Markham (CA); Kishor V. Patil, Toronto (CA); Ivan K. Y. Sham, Vancouver (CA)

(73) Assignee: INTERNATIONAL BUSINESS MACHINES CORPORATION, Armonk, NY (US)

(21) Appl. No.: 13/269,582

(22) Filed: Oct. 8, 2011

(30) Foreign Application Priority Data
Nov. 5, 2010 (CA) 2719661

(51) Int. Cl. G06F 9/44

(52) U.S. Cl. 717/163

(57) ABSTRACT

An enhanced function-descriptor-based dispatch in a multi-linkage environment receives user code containing a function compiled in a supplementary linkage convention of a caller to form an invoked function and determines whether the supplementary linkage convention of the caller for the invoked function matches a supplementary linkage implementation provided by a library. Responsive to a determination that the supplementary linkage convention of the caller for the invoked function matches a supplementary linkage implementation provided by the library, an embodiment selects the supplementary linkage implementation provided by the library and dispatches the invoked function in the selected supplementary linkage implementation provided by the library.

### BACKGROUND

This disclosure relates generally to programming languages and compilers in a data processing system and more specifically to reduced linkage conversion overhead in the data processing system.

Compilers use linkage conventions to handle transfer of control and data between a caller function and a called function. Depending upon the compiler versions, languages, and manufacturers, different linkage conventions are used. When the caller and called function use the same linkage convention, transfer of control and data incurs no linkage conversion overhead. When the caller function uses different linkage convention than the called function, a set of run-time compatibility glue routines transform the data passed by the caller function into the format expected by the called function according to called function linkage convention. The glue routines may need to do further housekeeping to provide run-time support, including stack trace, and execution signal handling, in this mixed environment.

Software systems typically consist of pre-packaged general-purpose third party libraries as well as application code. The third party libraries provide common set of services through application programming interface (API) implementations compiled in one linkage. The application programming interfaces may be called from application code using any linkage convention. In such systems, inter-operating between software modules with different linkage conventions incurs significant performance overhead.

For example, existing legacy application code uses older linkage conventions. In typical enterprise modernization projects, parts of the legacy software system are re-implemented in modern languages using more recent linkage conventions. In the example, legacy COBOL applications running on System z®¹ using Language Environment® (LE) standard linkage convention is being partially replaced by Java®² modules. In order for COBOL to interact with Java modules and the Java Virtual Machine (JVM), COBOL applications use a set of standard Java Native Interface (JNI) API functions provided by the JVM that use high-performance (HP) linkage. In such a mixed execution environment, the application performance is typically degraded due to the linkage conversion glue routine overhead incurred at each transition between COBOL code and the JVM.

In a typical mixed-linkage environment, a vendor library either provides pre-initialized function tables containing function pointers, or the function pointers are obtained by caller code via POSIX®³ dlqueryfn call. For example, a Java VM maintains an array of function pointers initialized during JVM initialization. The native code of the user application makes a dynamic linked library API function call using a function pointer found at a known offset in the JNI function table provided by the JVM. A function pointer is a reference to a function descriptor, which may include executable glue code and linkage convention metadata including, but not limited to, an entry point address of a function.

To allow inter-operation between software modules with different linkage conventions, a composite function descriptor is created. Such a function descriptor consists of a legacy part, which has a same structure as the legacy function descriptor, and a second part, which has additional data/glue code to satisfy the needs of a new linkage convention.

The relevant part is modified to dispatch to a catch-all and know-it-all glue routine that recognizes the linkage of caller and called functions and transforms the linkage data, including parameters, and stack layout to match the linkage of the called function. ¹System z® and Language Environment are registered trademarks of International Business Machines Corporation in the United States, other countries, or both.² Java is a registered trademark of Oracle America, Inc. and/or its affiliates.³ POSIX is a registered trademark of Institute of Electrical and Electronic Engineers Inc.

Alternatively, venders provide separate binary modules of libraries compiled with different linkage conventions. This approach allows user code to link with an optimal version of a library in terms of matching linkage convention between vendor library and user application.

### BRIEF SUMMARY

According to one embodiment, a computer-implemented process for an enhanced function-descriptor-based dispatch in a multi-linkage environment receives user code containing a function compiled in a supplementary linkage convention of a caller to form an invoked function and determines whether the supplementary linkage convention of the caller for the invoked function matches a supplementary linkage implementation provided by a library. Responsive to a determination that the supplementary linkage convention of the caller for the invoked function matches a supplementary linkage implementation provided by the library, an embodiment selects the supplementary linkage implementation provided by the library and dispatches the invoked function in the selected supplementary linkage implementation provided by the library.

### BRIEF DESCRIPTION OF THE SEVERAL VIEWS OF THE DRAWINGS

For a more complete understanding of this disclosure, reference is now made to the following detailed description, taken in conjunction with the accompanying drawings, wherein like reference numerals represent like parts.

FIG. 1 is a block diagram of an exemplary data processing system operable for various embodiments of the disclosure;

FIG. 2 is a block diagram of an enhanced function-descriptor-based dispatch in a multi-linkage environment, in accordance with various embodiments of the disclosure;

FIG. 3 is a sequence diagram of a function-descriptor-based dispatch in a multi-linkage environment, in accordance with one embodiment of the disclosure;

FIG. 4 is a sequence diagram of an enhanced function-descriptor-based dispatch in a multi-linkage environment, in accordance with one embodiment of the disclosure;

FIG. 5 is a sequence diagram of an enhanced function-descriptor-based dispatch in a multi-linkage environment using a primary linkage dispatch section, in accordance with one embodiment of the disclosure;

FIG. 6 is a sequence diagram of an enhanced function-descriptor-based dispatch in a multi-linkage environment using a modified supplementary linkage dispatch section, in accordance with one embodiment of the disclosure;

FIG. 7 is a sequence diagram of an enhanced function-descriptor-based dispatch in a multi-linkage environment using a modified supplementary linkage dispatch section and primary linkage implementation, in accordance with one embodiment of the disclosure;

FIG. 8 is a tabular view of function descriptor tables, in accordance with one embodiment of the disclosure; and

FIG. 9 is a flowchart of a process using an enhanced function-descriptor-based dispatch in a multi-linkage environment, in accordance with one embodiment of the disclosure.

### DETAILED DESCRIPTION

Although an illustrative implementation of one or more embodiments is provided below, the disclosed invention may be implemented using any number of techniques. This disclosure should in no way be limited to the illustrative implementations, drawings, and techniques illustrated below, including the exemplary designs and implementations illustrated and described herein, but may be modified within the scope of the appended claims along with their full scope of equivalents.

As will be appreciated by one skilled in the art, aspects of the present disclosure may be embodied as a system, method, or computer program product. Accordingly, aspects of the present disclosure may take the form of an entirely hardware embodiment, an entirely software embodiment (including firmware, resident software, micro-code, etc.), or an embodiment combining software and hardware aspects that may all generally be referred to herein as a “circuit”, “module”, or “system”. Furthermore, aspects of the present invention may take the form of a computer program product embodied in one or more computer readable medium(s) having computer readable program code embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, or a magnetic storage device or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with the computer-readable program code embodied therein, for example, either in baseband or as part of a carrier wave. Such a propagated signal may take a variety of forms, including but not limited to electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer-readable medium may be transmitted using any appropriate medium, including but not limited to wireless, wire line, optical fiber cable, RF, etc. or any suitable combination of the foregoing.

Computer program code for carrying out operations for aspects of the present invention may be written in any combination of one or more programming languages, including an object oriented programming language such as Java®, Smalltalk, C++, or the like and conventional procedural programming languages, such as the “C” programming language or similar programming languages. Java and all Java-based trademarks and logos are trademarks of Oracle America, Inc., in the United States, other countries or both. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer or other programmable data processing apparatus to function in a particular manner, such that the instructions stored in the computer readable medium produce an article of manufacture including instructions which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process, such that the instructions which execute on the computer or other programmable apparatus provide processes for implementing the functions/acts specified in the flowchart and/or block diagram block or blocks.

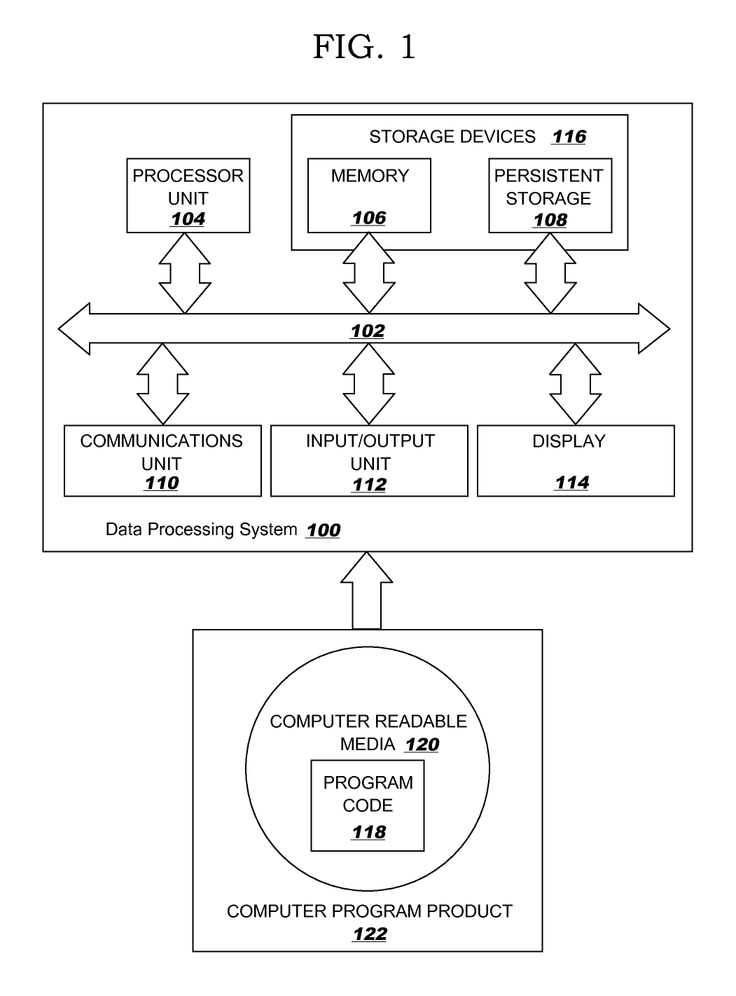

Turning now to FIG. 1, a block diagram of an exemplary data processing system operable for various embodiments of the disclosure is presented. In this illustrative example, data processing system 100 includes communications fabric 102, which provides communications between processor unit 104, memory 106, persistent storage 108, communications unit 110, input/output (I/O) unit 112, and display 114.

Processor unit 104 serves to execute instructions for software that may be loaded into memory 106. Processor unit 104 may be a set of one or more processors or may be a multi-processor core, depending on the particular implementation. Further, processor unit 104 may be implemented using one or more heterogeneous processor systems in which a main processor is present with secondary processors on a single chip. As another illustrative example, processor unit 104 may be a symmetric multi-processor system containing multiple processors of the same type.

Memory 106 and persistent storage 108 are examples of storage devices 116. A storage device is any piece of hardware that is capable of storing information, such as, for example without limitation, data, program code in functional form, and/or other suitable information either on a temporary basis and/or a permanent basis. Memory 106, in these examples, may be, for example, a random access memory or any other suitable volatile or non-volatile storage device. Persistent storage 108 may take various forms depending on the particular implementation. For example, persistent storage 108 may contain one or more components or devices. For example, persistent storage 108 may be a hard drive, a flash memory, a rewritable optical disk, a rewritable magnetic tape, or some combination of the above. The media used by persistent storage 108 also may be removable. For example, a removable hard drive may be used for persistent storage 108.

Communications unit 110, in these examples, provides for communications with other data processing systems or devices. In these examples, communications unit 110 is a network interface card. Communications unit 110 may provide communications through the use of either or both physical and wireless communications links.

Input/output unit 112 allows for input and output of data with other devices that may be connected to data processing system 100. For example, input/output unit 112 may provide a connection for user input through a keyboard, a mouse, and/or some other suitable input device. Further, input/output unit 112 may send output to a printer. Display 114 provides a mechanism to display information to a user.

Instructions for the operating system, applications, and/or programs may be located in storage devices 116, which are in communication with processor unit 104 through communications fabric 102. In these illustrative examples, the instructions are in a functional form on persistent storage 108. These instructions may be loaded into memory 106 for execution by processor unit 104. The processes of the different embodiments may be performed by processor unit 104 using computer-implemented instructions, which may be located in a memory, such as memory 106.

These instructions are referred to as program code, computer usable program code, or computer readable program code that may be read and executed by a processor in processor unit 104. The program code in the different embodiments may be embodied on different physical or tangible computer readable media, such as memory 106 or persistent storage 108.

Program code 118 is located in a functional form on computer readable media 120 that is selectively removable and may be loaded onto or transferred to data processing system 100 for execution by processor unit 104. Program code 118 and computer readable media 120 form computer program product 122 in these examples. In one example, computer readable media 120 may be in a tangible form, such as, for example, an optical or magnetic disc that is inserted or placed into a drive or other device that is part of persistent storage 108 for transfer onto a storage device, such as a hard drive that is part of persistent storage 108. In a tangible form, computer readable media 120 also may take the form of a persistent storage, such as a hard drive, a thumb drive, or a flash memory that is connected to data processing system 100. The tangible form of computer readable media 120 is also referred to as computer recordable storage media. In some instances, computer readable media 120 may not be removable.

Alternatively, program code 118 may be transferred to data processing system 100 from computer readable media 120 through a communications link to communications unit 110 and/or through a connection to input/output unit 112. The communications link and/or the connection may be physical or wireless in the illustrative examples. The computer readable media also may take the form of non-tangible media, such as communications links or wireless transmissions containing the program code.

In some illustrative embodiments, program code 118 may be downloaded over a network to persistent storage 108 from another device or data processing system for use within data processing system 100. For instance, program code stored in a computer readable storage medium in a server data processing system may be downloaded over a network from the server to data processing system 100. The data processing system providing program code 118 may be a server computer, a client computer, or some other device capable of storing and transmitting program code 118.

The different components illustrated for data processing system 100 are not meant to provide architectural limitations to the manner in which different embodiments may be implemented. The different illustrative embodiments may be implemented in a data processing system including components in addition to or in place of those illustrated for data processing system 100. Other components shown in FIG. 1 can be varied from the illustrative examples shown. The different embodiments may be implemented using any hardware device or system capable of executing program code. As one example, the data processing system may include organic components integrated with inorganic components and/or may be comprised entirely of organic components excluding a human being. For example, a storage device may be comprised of an organic semiconductor.

As another example, a storage device in data processing system 100 may be any hardware apparatus that may store data. Memory 106, persistent storage 108, and computer readable media 120 are examples of storage devices in a tangible form.

In another example, a bus system may be used to implement communications fabric 102 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 106 or a cache such as found in an interface and memory controller hub that may be present in communications fabric 102.

According to an illustrative embodiment, a computer-implemented process for reduced linkage conversion overhead provides a framework, enabling vendors to provide augmented versions of existing software libraries, which typically reduces linkage conversion overhead without requiring changes to a consumer of such libraries. Existing user applications can typically experience performance improvement transparently from the reduction of linkage conversion overhead by replacing a third party library module with an augmented library module.

Using data processing system 100 of FIG. 1 as an example, an illustrative embodiment provides the computer-implemented process stored in memory 106, executed by processor unit 104, for an enhanced function-descriptor-based dispatch in a multi-linkage environment. Processor unit 104 receives user code containing a function compiled in a supplementary linkage convention of a caller from communications unit 110, input/output unit 112, or storage devices 116, to form an invoked function. Processor unit 104 determines whether the supplementary linkage convention of the caller for the invoked function matches a supplementary linkage implementation provided by a library stored on storage devices 116. Responsive to a determination that the supplementary linkage convention of the caller for the invoked function matches a supplementary linkage implementation provided by the library, processor unit 104 selects the supplementary linkage implementation provided by the library and dispatches the invoked function in the selected supplementary linkage implementation provided by the library.

In another example, a computer-implemented process, using program code 118 stored in memory 106 or as a computer program product 122, for an enhanced function-descriptor-based dispatch in a multi-linkage environment is presented. In an alternative embodiment, program code 118 containing the computer-implemented process may be stored within computer readable media 120 as computer program product 122. In another illustrative embodiment, an enhanced function-descriptor-based dispatch in a multi-linkage environment may be implemented in an apparatus comprising a communications fabric, a memory connected to the communications fabric, wherein the memory contains computer executable program code, a communications unit connected to the communications fabric, an input/output unit connected to the communications fabric, a display connected to the communications fabric, and a processor unit connected to the communications fabric. The processor unit of the apparatus executes the computer executable program code to direct the apparatus to perform the process.

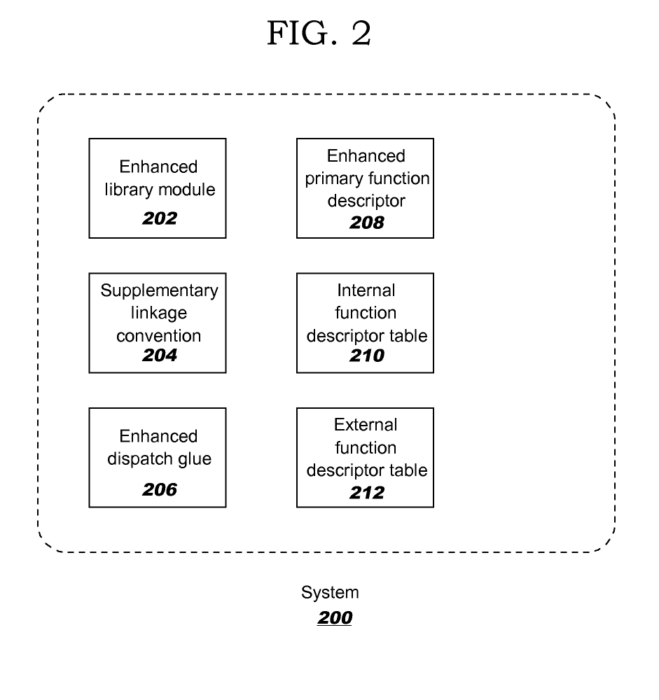

With reference to FIG. 2, a block diagram of components for an enhanced function-descriptor-based dispatch in a multi-linkage environment, in accordance with various embodiments of the disclosure, is presented. A data structure may be represented in a table form. System 200 is an example of components providing a capability of an enhanced function-descriptor-based dispatch in a multi-linkage environment including components of an underlying data processing system such as data processing system 100 of FIG. 1. System 200 also assumes support of compiling and linking components within the underlying system, although not shown or described further.

System 200 comprises a number of components including an enhanced library module 202, supplementary linkage convention 204, enhanced dispatch glue 206, enhanced primary function descriptor 208, internal function descriptor table 210, and external function descriptor table 212. (References herein to use of a table are meant as an example implementation of a data structure and are not meant as a limitation to only a tabular embodiment. Other embodiments of a data structure may be used to provide suitable capability for storage, maintenance, and retrieval of data.) Components of system 200 may be implemented as separate components or combinations of components, as required, without limiting the scope of the disclosed subject matter.

Enhanced library module 202 contains multiple versions of functions invoked by calling user code. The multiple versions are differentiated into a primary linkage implementation and a set of supplementary linkage implementations. Enhanced library module 202 contains a primary linkage implementation for each function supported by the library but is not required to provide supplementary linkage implementations for each function supported by the library. Enhanced library module 202 may also be referred to as a vendor library or third party library but is not restricted to such providers.

Supplementary linkage convention 204 defines a linkage convention that is different from, and an alternative to, a primary linkage convention as typically provided by a function library. For example, the function library may provide support in primary linkage of programming language A, while user code may invoke the function using a supplementary linkage convention of programming language B.

Enhanced dispatch glue 206 is a mechanism or set of routines providing a capability to identify and select an appropriate method during invocation of the function call made by the user code. The identification and selection process typically uses a data structure such as internal function descriptor table 210 or external function descriptor table 212.

Enhanced primary function descriptor 208 is upgraded in a compatibility part of the original primary function descriptor to include a supplementary linkage dispatch section that is updated to jump to new dispatch glue. A primary linkage dispatch section used by user code using primary linkage convention is not changed from prior implementations.

Internal function descriptor table 210 contains a row for each of the methods exported by the function library and a set of columns for each supplementary linkage supported. Each column, other than the function column, corresponds to a supplementary linkage supported by linkage conversion glue. A table is one example of an implementation. Other forms of data structures may be used to accomplish the same service.

External function descriptor table 212 comprises a set of definitions in which function descriptors are patched. The metadata provided indicates that the supplementary linkage dispatch section provides a redirection to dispatch glue introduced in the function-descriptor-based dispatch in a multi-linkage environment, while the dispatch for the primary linkage section remains unchanged.

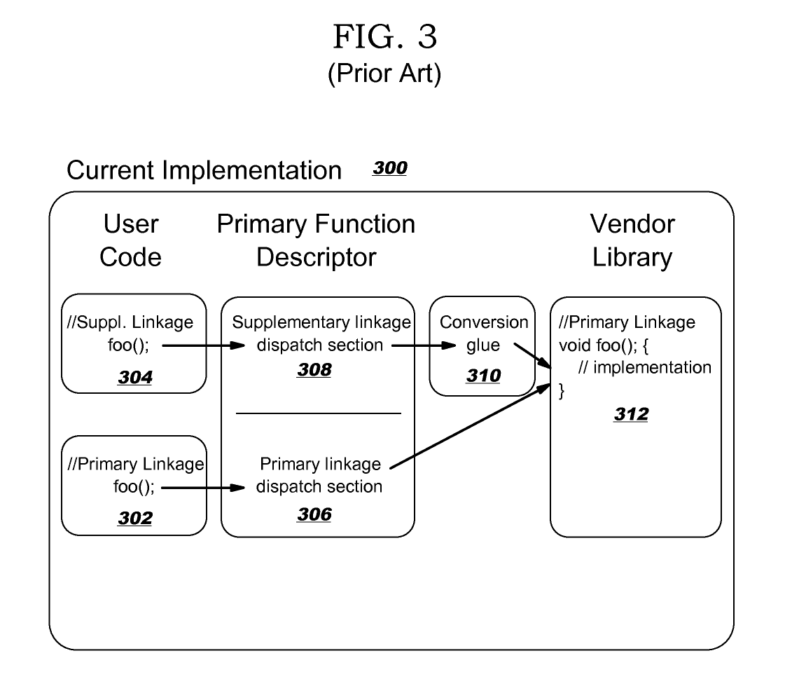

With reference to FIG. 3, a sequence diagram of a function-descriptor-based dispatch in a multi-linkage environment is presented. Sequence 300 depicts a current implementation of function-descriptor-based dispatch in a multi-linkage environment when a library method is invoked.

In the example of sequence 300, a user invokes a method foo( ) from a module using a primary linkage convention 302. A current implementation typically uses primary linkage dispatch section 306 of the primary function descriptor as an entry point to a primary linkage implementation 312 of foo( ) in a vendor library.

When a user invokes the method foo( ) from a module using any one of the supplementary linkage conventions 304, the current implementation uses the supplementary linkage dispatch section 308 in the function descriptor as an entry point to primary linkage implementation 312 of foo( ) in the vendor library. In this scenario, instead of directly jumping to primary linkage implementation 312 of foo( ), an execution of a run-time routine of conversion glue 310 is required to perform linkage conversion from the caller linkage convention to the vendor library linkage convention.

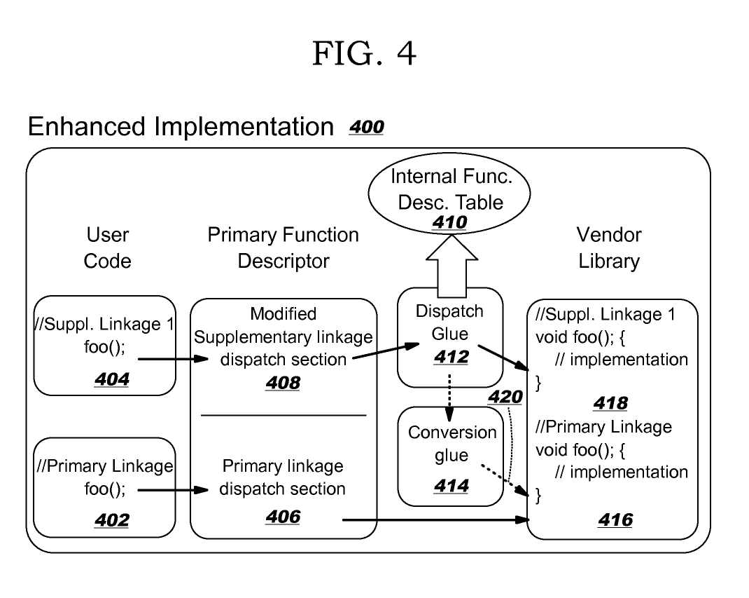

With reference to FIG. 4, a sequence diagram of an enhanced function-descriptor-based dispatch in a multi-linkage environment in accordance with one embodiment of the disclosure is presented. Sequence 400 depicts an enhanced implementation of function-descriptor-based dispatch in a multi-linkage environment when a library method is invoked. In the illustrative embodiment, a computer-implemented process provides an improved mechanism to dispatch to a specific implementation of a method, thereby avoiding expensive linkage conversion.

In the example, sequence 400 typically improves the current implementation of sequence 300 of FIG. 3 by introducing multiple implementations of foo( ) using different linkage conventions, primary linkage implementation 416 and a set of supplementary linkage implementation 418 and a mechanism, in the form of an internal function description table 410, dispatch glue 412, and conversion glue 414 to provide efficient dispatch from the caller to the appropriate method implementation of primary linkage implementation 416 and a set of supplementary linkage implementations 418 in the vendor library.

Under the enhanced implementation, the vendor is required to provide a full implementation of all methods in the library with the primary linkage convention 416. Vendors may choose to provide other implementations with supplementary linkage implementations 418 to avoid linkage conversion when these library methods are called by user code using supplementary linkage convention 404.

The vendor library contains multiple versions of the implementation of the method foo( ) with different linkage conventions of primary linkage implementation 416 and a set of supplementary linkage conventions 418. The set of supplementary linkage implementations 418 contains one or more instances of supplementary linkage implementations 418. A new dispatch glue 412 is introduced to determine an optimal implementation of foo( ) for execution. A compatibility part of the original primary function descriptor, supplementary linkage dispatch section 408, is updated to jump to the new dispatch glue. Primary linkage dispatch section 406 as used by user code using primary linkage convention 402 is not changed from prior implementations.

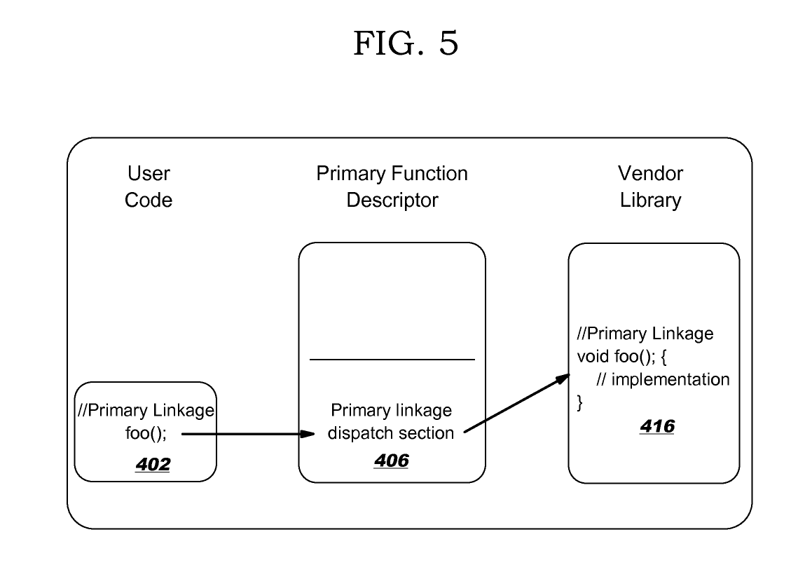

It is not necessary to provide method implementations in each of the supplementary linkage implementation 418. Dispatch glue 412 will use the primary linkage implementation 416 through the routine of conversion glue 414, indicated by path 420, when a matching supplementary linkage implementation 418 is not found. Under the enhanced implementation of sequence 400, three possible scenarios occur when user code invokes a method provided by the vendor library, as described in FIG. 5 through FIG. 7.

With reference to FIG. 5, a sequence diagram of an enhanced function-descriptor-based dispatch in a multi-linkage environment using a primary linkage dispatch section in accordance with one embodiment of the disclosure is presented. Sequence 500 depicts an example using the enhanced function-descriptor-based dispatch in a multi-linkage environment of FIG. 4 in which the user code using a primary linkage convention 402 is compiled with the primary linkage implementation provided by a vendor library. The execution path is through primary linkage dispatch section 406 of the primary function descriptor to a primary linkage implementation 416 in the vendor library and is identical to that described for the current implementation of sequence 300 of FIG. 3.

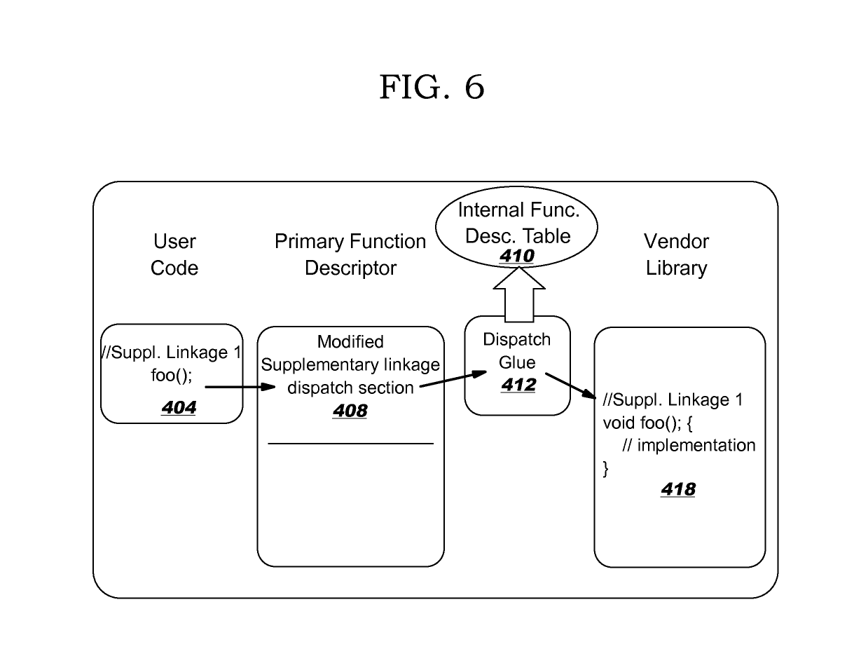

With reference to FIG. 6, a sequence diagram of an enhanced function-descriptor-based dispatch in a multi-linkage environment using a modified supplementary linkage dispatch section in accordance with one embodiment of the disclosure is presented. Sequence 600 depicts an example using the enhanced function-descriptor-based dispatch in a multi-linkage environment of FIG. 4 in which the user code uses supplementary linkage convention 404 and a vendor library contains implementation of a called function in matching supplementary linkage implementation 418.

When the user code is compiled with a supplementary linkage implementation 418 provided by the vendor library, dispatch glue 412 will pick an implementation of the invoked method that matches the linkage convention of the caller using internal function descriptor table 410 to match supplementary linkage implementation 418. By dispatching to an implementation with matching linkage convention, the overhead for conversion glue 414 of FIG. 4 is avoided.

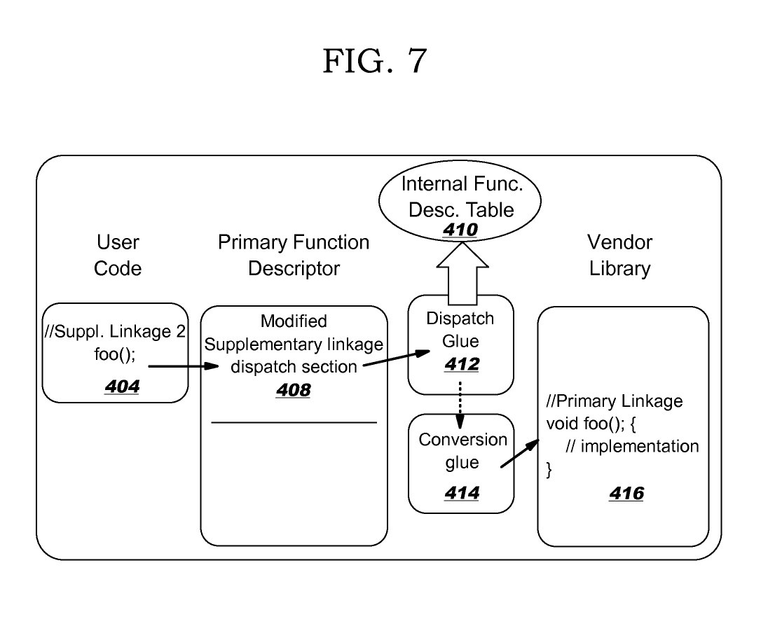

With reference to FIG. 7, a sequence diagram of an enhanced function-descriptor-based dispatch in a multi-linkage environment using a modified supplementary linkage dispatch section and primary linkage implementation in accordance with one embodiment of the disclosure is presented. Sequence 700 depicts an example using the enhanced function-descriptor-based dispatch in a multi-linkage environment of FIG. 4 in which the user code uses supplementary linkage convention 404 but the vendor library does not provide an implementation of a called function in that specific supplementary linkage.

When user code is compiled with a supplementary linkage convention 404 and the called function implementation in matching linkage is not provided by the vendor library, dispatch glue 412 will pick an implementation of the invoked method with the primary linkage implementation 416 used by the vendor library. This path is similar to the current implementation of sequence 300 of FIG. 3 when user code does not match the linkage convention used by the vendor library.

Dispatch glue 412 uses internal function descriptor table 410 provided by the vendor library to determine an optimal implementation for a method during execution. Internal function descriptor table 410 is initialized prior to invocation of any methods provided by the vendor library.

A determination of the set of internal function descriptors to use in dispatch glue 412 is made using modified supplementary linkage dispatch section 408 in the primary function descriptor to set up metadata before invoking dispatch glue 412. The metadata provides the location of a set of function descriptors of interest in internal function descriptor table 410. The metadata can also include the linkage convention used by the caller of the vendor library method.

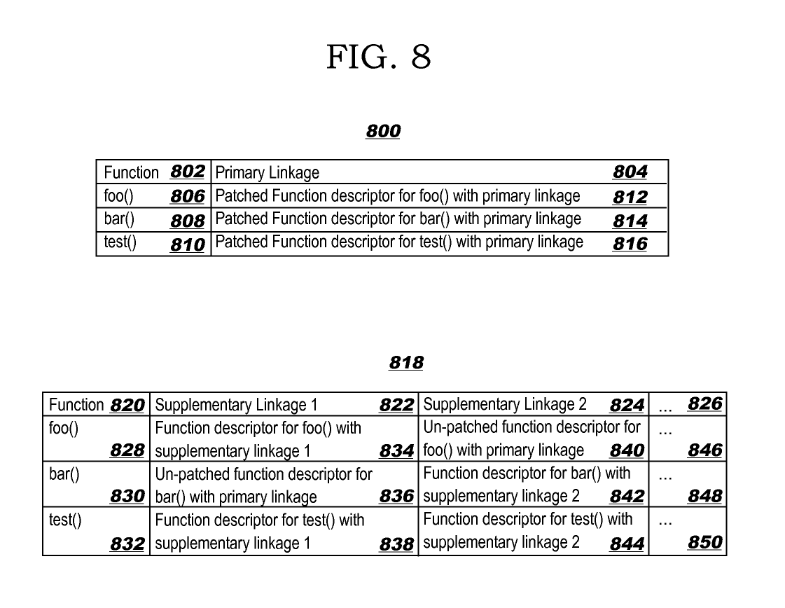

With reference to FIG. 8, a tabular view of function descriptor tables is presented. Table 818 is an example of a table showing a structure of the internal function descriptor table 410 of FIG. 4. The internal function descriptor table example of table 818 contains a row for each of the methods exported by a vendor library and a set of columns for each supplementary linkage supported. In the example, a header of table 818 indicates column headings of function 820, supplementary linkage 1 822, supplementary linkage 2 824, and a last column containing 826. The entry “ . . . ” indicates content of another supplementary linkage that is not described but exists. Each column, other than the function column, corresponds to a supplementary linkage supported by the linkage conversion glue. For example, when the linkage conversion routine supports two linkage conventions, the internal function descriptor table will have two linkage columns. In the example, functions foo( ) 828, bar( ) 830, and test( ) 832 are exported and have differing combinations of supporting supplementary linkages.

The vendor library is required to provide the implementation of the full set of exported methods in primary linkage convention, but the vendor can choose to only provide an arbitrary subset of the exported methods in supplementary linkage(s). For methods that do not have an implementation in a specific supplementary linkage, the corresponding slot in the internal function descriptor table will contain the un-patched function descriptor for the same method using primary linkage. For example, function foo( ) 828 has a supplementary linkage 1 822 as indicated by the entry “Function descriptor for foo( ) with supplementary linkage 1” 834 but does not have a supplementary linkage 2 824 as indicated by the entry “Un-patched function descriptor for foo( ) with primary linkage” 840. Function bar( ) 830 has a supplementary linkage 2 824 as indicated by the entry “Function descriptor for bar( ) with supplementary linkage 2” 842 but does not have a supplementary linkage 1 822 as indicated by the entry “Un-patched function descriptor for bar( ) with primary linkage” 836. Function test( ) 832 has a supplementary linkage 1 822 as indicated by the entry “Function descriptor for test( ) with supplementary linkage 1” 838 and has a supplementary linkage 2 824 as indicated by the entry “Function descriptor for test( ) with supplementary linkage 2” 844. As previously stated, entries of column 826 are defined but not described and would be similar to entries just described.

The vendor library also needs to provide an external function descriptor table, which is used by user code to invoke exported methods in the library. The structure of the external function descriptor table is similar to that of the internal function descriptor table. The external function descriptor table, such as table 800, contains a column indicating the function, such as function 802, and a column for the function descriptor for the implementation of the exported method with primary linkage, such as primary linkage 804.

Table 800 provides an example of the structure of the external function descriptor table in which function descriptors are patched such that the supplementary linkage dispatch section provides a redirection to the dispatch glue introduced in this invention, while the dispatch for the primary linkage section remains unchanged.

In table 800, the vendor library exports three methods foo( ) 806, bar( ) 808, and test( ) 810. Each method is available in a different combination of implementations of foo( ) 806, available in primary linkage and supplementary linkage 1, bar( ) 808, available in primary linkage and supplementary linkage 2, and test( ) 810, available in primary linkage and supplementary linkage 1 and 2.

When user code using supplementary linkage 2 invokes function foo( ) the dispatch glue will use the function descriptor under Supplementary Linkage 2 824 column for foo( ) 828 of table 818, which will cause the run-time support to invoke the linkage conversion glue before being dispatched to the implementation of foo( ) with primary linkage.

Alternative implementations of vendor API functions may reside in separate supplementary dynamic load libraries (DLLs) or they may be packaged within a single DLL. In the case where separate libraries are used, the DLL providing primary linkage implementations loads the supplementary DLLs to resolve and initialize the entries of the function descriptor table.

When the function descriptor table is initialized, the original function descriptor for all of the exported methods implemented in a primary linkage is patched, such that the supplementary linkage dispatch section of the function descriptor jumps to the new dispatch glue.

When there are only two possible linkage conventions comprising a primary linkage and one supplementary linkage, rather than using an internal function descriptor table and dispatch glue, the supplementary linkage dispatch section of the primary linkage function descriptor in the external function descriptor table may be patched to dispatch to the supplementary linkage implementation, when one exists.

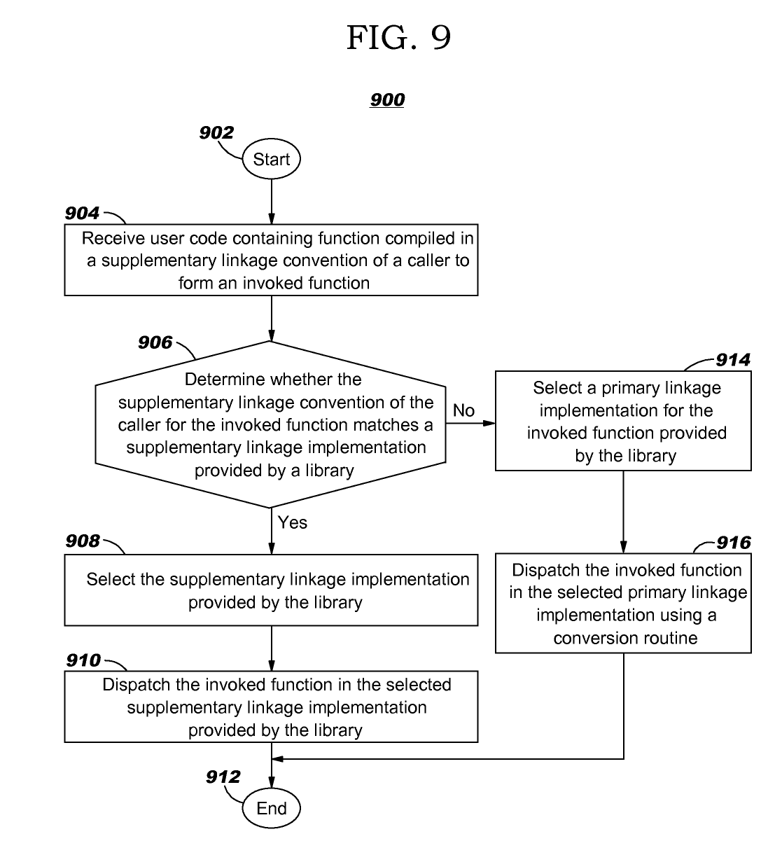

With reference to FIG. 9, a flowchart of a process using an enhanced function-descriptor-based dispatch in a multi-linkage environment in accordance with one embodiment of the disclosure is presented. Process 900 is an example of using an enhanced function-descriptor-based dispatch in a multi-linkage environment of sequence 400 of FIG. 4.

Process 900 begins (step 902) and receives user code containing a function compiled in a supplementary linkage convention of a caller to form an invoked function (step 904). Process 900 determines whether the supplementary linkage convention of the caller for the invoked function matches a supplementary linkage implementation provided by a library (step 906). Responsive to a determination that the supplementary linkage convention of the caller for the invoked function matches a supplementary linkage implementation provided by a library, process 900 selects the supplementary linkage implementation provided by the library (step 908). Identification and selection of the supplementary linkage implementation provided by the library may be performed using a table or set of tables as in the example of FIG. 8.

Process 900 dispatches the invoked function in the selected supplementary linkage implementation provided by the library (step 910) and terminates thereafter (step 912). Responsive to a determination that the supplementary linkage convention of the caller for the invoked function does not match a supplementary linkage implementation provided by a library, process 900 selects a primary linkage implementation provided by the library (step 914).

Process 900 dispatches the invoked function in the selected primary linkage implementation provided by the library using a conversion routine (step 916) and terminates thereafter (step 912). The conversion may be a conversion glue routine as in the example of FIG. 4.

Thus is provided in one embodiment a computer-implemented process for an enhanced function-descriptor-based dispatch in a multi-linkage environment. The computer-implemented process receives user code containing a function compiled in a supplementary linkage convention of a caller to form an invoked function, and determines whether the supplementary linkage convention of the caller for the invoked function matches a supplementary linkage implementation provided by a library. Responsive to a determination that the supplementary linkage convention of the caller for the invoked function matches a supplementary linkage implementation provided by the library, the embodiment selects the supplementary linkage implementation provided by the library and dispatches the invoked function in the selected supplementary linkage implementation provided by the library.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing a specified logical function. It should also be noted that, in some alternative implementations, the functions noted in the block might occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed.

As noted earlier, the invention can take the form of an entirely hardware embodiment, an entirely software embodiment or an embodiment containing both hardware and software elements. In a preferred embodiment, the invention is implemented in software, which includes but is not limited to firmware, resident software, microcode, and other software media that may be recognized by one skilled in the art.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

As discussed with reference to FIG. 1, a data processing system suitable for storing and/or executing program code will include at least one processor coupled directly or indirectly to memory elements through a communication fabric such as a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The described embodiment was chosen and described in order to best explain the principles of the invention, the practical application, and to enable others of ordinary skill in the art to understand the invention for various embodiments with various modifications as are suited to the particular use contemplated.

What is claimed is:

1. A computer-implemented process for an enhanced function-descriptor-based dispatch in a multi-linkage environment, the computer-implemented process comprising:
receiving user code containing a function compiled in a supplementary linkage convention of a caller to form an invoked function;
determining whether the supplementary linkage convention of the caller for the invoked function matches a supplementary linkage implementation provided by a library;
responsive to a determination that the supplementary linkage convention of the caller for the invoked function matches a supplementary linkage implementation provided by the library, selecting the supplementary linkage implementation provided by the library; and
dispatching the invoked function in the selected supplementary linkage implementation provided by the library.

2. The computer-implemented process of claim 1, further comprising:
responsive to a determination that the supplementary linkage convention of the caller for the invoked function does not match a supplementary linkage implementation provided by the library, selecting a primary linkage implementation provided by the library; and
dispatching the invoked function in the selected primary linkage implementation provided by the library using a conversion routine.

3. The computer-implemented process of claim 1, wherein determining whether the supplementary linkage convention of the caller for the invoked function matches a supplementary linkage implementation provided by a library further comprises:
using a modified supplementary linkage dispatch section of a primary function descriptor.

4. The computer-implemented process of claim 1, wherein determining whether the supplementary linkage convention of the caller for the invoked function matches a supplementary linkage implementation provided by a library further comprises:
using an internal function descriptor table, wherein the internal function descriptor table contains metadata defining methods exported by the library and supplementary linkages supported by linkage conversion.

5. The computer-implemented process of claim 1, wherein support for the library comprises:
an external function descriptor table used to invoke exported methods of the library, wherein the external function descriptor table contains metadata defining methods exported by the library and supplementary linkages supported by linkage conversion.

6. The computer-implemented process of claim 1, wherein determining whether the supplementary linkage convention of the caller for the invoked function matches a supplementary linkage implementation provided by a library further comprises:
initializing an internal function descriptor table prior to invocation of methods supported by the library.

7. The computer-implemented process of claim 1, further comprising:
patching a supplementary linkage dispatch section of a primary linkage function descriptor in an external function descriptor table to dispatch to a supplementary linkage implementation, when the supplementary linkage implementation exists.

8. A computer program product for an enhanced function-descriptor-based dispatch in a multi-linkage environment, the computer program product comprising:
a computer recordable-type media containing computer executable program code stored thereon, the computer executable program code comprising:
computer executable program code for receiving user code containing a function compiled in a supplementary linkage convention of a caller to form an invoked function;
computer executable program code for determining whether the supplementary linkage convention of the caller for the invoked function matches a supplementary linkage implementation provided by a library;
computer executable program code responsive to a determination that the supplementary linkage convention of the caller for the invoked function matches a supplementary linkage implementation provided by the library, for selecting the supplementary linkage implementation provided by the library; and
computer executable program code for dispatching the invoked function in the selected supplementary linkage implementation provided by the library.

9. The computer program product of claim 8, further comprising:
computer executable program code responsive to a determination that the supplementary linkage convention of the caller for the invoked function does not match a supplementary linkage implementation provided by the library, for selecting a primary linkage implementation provided by the library; and
computer executable program code for dispatching the invoked function in the selected primary linkage implementation provided by the library using a conversion routine.

10. The computer program product of claim 8, wherein computer executable program code for determining whether the supplementary linkage convention of the caller for the invoked function matches a supplementary linkage implementation provided by a library further comprises:
computer executable program code for using a modified supplementary linkage dispatch section of a primary function descriptor.

11. The computer program product of claim 8, wherein computer executable program code for determining whether the supplementary linkage convention of the caller for the invoked function matches a supplementary linkage implementation provided by a library further comprises:
computer executable program code for using an internal function descriptor table, wherein the internal function descriptor table contains metadata defining methods exported by the library and supplementary linkages supported by linkage conversion.

12. The computer program product of claim 8, wherein computer executable program code for support for the library comprises:
computer executable program code for an external function descriptor table used to invoke exported methods of the library, wherein the external function descriptor table contains metadata defining methods exported by the library and supplementary linkages supported by linkage conversion

13. The computer program product of claim 8, wherein computer executable program code for determining whether the supplementary linkage convention of the caller for the invoked function matches a supplementary linkage implementation provided by a library further comprises:
computer executable program code for initializing an internal function descriptor table prior to invocation of methods supported by the library.

14. The computer program product of claim 8, further comprising:
computer executable program code for patching a supplementary linkage dispatch section of a primary linkage function descriptor in an external function descriptor table to dispatch to a supplementary linkage implementation, when the supplementary linkage implementation exists.

15. An apparatus for an enhanced function-descriptor-based dispatch in a multi-linkage environment, the apparatus comprising:
a communications fabric;
a memory connected to the communications fabric, wherein the memory contains computer executable program code;
a communications unit connected to the communications fabric;
an input/output unit connected to the communications fabric;
a display connected to the communications fabric; and
a processor unit connected to the communications fabric, wherein the processor unit executes the computer executable program code to direct the apparatus to:
receive user code containing a function compiled in a supplementary linkage convention of a caller to form an invoked function;
determine whether the supplementary linkage convention of the caller for the invoked function matches a supplementary linkage implementation provided by a library;
responsive to a determination that the supplementary linkage convention of the caller for the invoked function matches a supplementary linkage implementation provided by the library, select the supplementary linkage implementation provided by the library; and
dispatch the invoked function in the selected supplementary linkage implementation provided by the library.

16. The apparatus of claim 15, wherein the processor unit further executes the computer executable program code to direct the apparatus to:
responsive to a determination that the supplementary linkage convention of the caller for the invoked function does not match a supplementary linkage implementation provided by the library, select a primary linkage implementation provided by the library; and
dispatch the invoked function in the selected primary linkage implementation provided by the library using a conversion routine.

17. The apparatus of claim 15, wherein the processor unit executes the computer executable program code to determine whether the supplementary linkage convention of the caller for the invoked function matches a supplementary linkage implementation provided by a library further directs the apparatus to:
use a modified supplementary linkage dispatch section of a primary function descriptor.

18. The apparatus of claim 15, wherein the processor unit executes the computer executable program code to determine whether the supplementary linkage convention of the caller for the invoked function matches a supplementary linkage implementation provided by a library further directs the apparatus to:
use an internal function descriptor table, wherein the internal function descriptor table contains metadata defining methods exported by the library and supplementary linkages supported by linkage conversion.

19. The apparatus of claim 15. wherein the processor unit executes the computer executable program code to support for the library further directs the apparatus to:
Use an external function descriptor table to invoke exported methods of the library, wherein the external function descriptor table contains metadata defining methods exported by the library and supplementary linkages supported by linkage conversion

20. The computer-implemented process of claim 1, further comprising, responsive to determining that the supplementary linkage convention of the caller for the invoked function matches a supplementary linkage implementation provided by a library:
initializing an internal function descriptor table prior to invocation of methods supported by the library; and
patching a supplementary linkage dispatch section of a primary linkage function descriptor in an external function descriptor table to dispatch to a supplementary linkage implementation, when the supplementary linkage implementation exists.
